(19) United States
(12) Patent Application Publication
(10) Pub. No.: US 2019/0169363 A1
(43) Pub. Date: Jun. 6, 2019

(54) AMORPHOUS THERMOPLASTIC POLYESTER FOR THE PRODUCTION OF OPTICAL ARTICLES

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/323,156

(22) PCT Filed: Aug. 3, 2017
(86) PCT No.: PCT/FR2017/052182

§ 371 Date: Feb. 4, 2019

(30) Foreign Application Priority Data
Aug. 5, 2016 (FR) 16 57614

(51) Int. Cl. C08G 63/199

(52) U.S. Cl. CPC C08G 63/199; B29D 11/00

(57) ABSTRACT

The invention relates to the use of an amorphous thermoplastic polyester for the production of optical articles, said thermoplastic polyester having at least one 1,4:3,6-dianhydrohexitol unit (A), at least one alicyclic diol unit (B) other than the 1,4:3,6-dianhydrohexitol units (A), at least one terephthalic acid unit (C), the molar ratio (A)/[(A)+(B)] being at least 0.32 and at most 0.90, said polyester being free of non-cyclic aliphatic diol units or comprising a molar amount of non-cyclic aliphatic diol units, relative to the total monomeric units in the polyester, of less than 5%, and with a reduced viscosity in solution (25° C.; phenol (50 wt. %): ortho-dichlorobenzene (50 wt. %); 5 g/L of polyester) greater than 50 mL/g.

### FIELD OF THE INVENTION

The present invention relates to the use of an amorphous thermoplastic polyester comprising at least one 1,4:3,6-dianhydrohexitol unit, which can have excellent impact strength properties, for the production of optical articles.

### TECHNICAL BACKGROUND OF THE INVENTION

Because of their numerous advantages, plastics have become inescapable in the mass production of objects. Indeed, their thermoplastic character enables these materials to be transformed at a high rate into all kinds of objects.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of films.

However, for certain applications or under certain usage conditions, these polyesters do not have all the required properties, especially optical, impact strength or else heat resistance properties. This is why glycol-modified PETs (PETgs) have been developed. These are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties, especially when the PETg is amorphous.

Other modified PETs have also been developed by introducing, into the polyester, 1,4:3,6-dianhydrohexitol units, especially isosorbide (PEIT). These modified polyesters have higher glass transition temperatures than the unmodified PETs or the PETgs comprising CHDM. In addition, 1,4:3,6-dianhydrohexitols have the advantage of being able to be obtained from renewable resources such as starch.

One problem with these PEITs is that they may have insufficient impact strength properties. Furthermore, the glass transition temperature may be insufficient for certain applications wherein the parts are subjected to high working temperatures.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties.

As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% of isosorbide and 71% of CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide. Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, this being despite the use of prolonged synthesis times.

In the field of the production of optical articles, the polymers used must have optical properties, but also impact strength and scratch resistance and a low birefringence. However, these properties are not optimal with the polymers present on the market and there is still at the current time a need to find new thermoplastic polyesters which have the appropriate mechanical properties and also a reduced solution viscosity that is sufficiently high to be used in the production of optical articles and to provide good working properties of said articles.

Optical articles produced from polymers having terephthalic acid units, ethylene glycol units and isosorbide units and optionally another diol (for example 1,4-cyclohexanedimethanol) are known from document U.S. Pat. No. 6,126,992. All the polymers obtained thus have ethylene glycol units, since it is widely accepted that they are necessary for obtaining a high glass transition temperature. Moreover, the examples of preparation implemented do not make it possible to obtain polymers having high glass transition temperatures; on the contrary, they are even too low (106° C. for the polymer of example 1 and 116° C. for the polymer of example 2) to be entirely satisfactory in the production of optical articles.

Thus, there is currently still a need to find novel thermoplastic polyesters containing 1,4:3,6-dianhydrohexitol units for the production of optical articles, said polyesters thus having improved optical properties, being able to be easily formed and having high heat resistance and also high impact strength.

It is to the applicant's credit to have found that this objective can be achieved with an amorphous thermoplastic polyester comprising at least one 1,4:3,6-dianhydrohexitol unit, at least one unit of an alicyclic diol other than the 1,4:3,6-dianhydrohexitol units and at least one aromatic dicarboxylic acid unit, while at the same time not containing any ethylene glycol units, although it was known up until now that the latter was essential for the incorporation of said isosorbide into the polyester.

### SUMMARY OF THE INVENTION

Thus, a subject of the invention is the use of an amorphous thermoplastic polyester for the production of optical articles, said amorphous thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);

the (A)/[(A)+(B)] molar ratio being at least 0.32 and at most 0.90 and the reduced viscosity in solution being greater than 50 ml/g,

said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g.

A second subject of the invention relates to a process for producing optical articles based on the amorphous thermoplastic polyester described above.

Finally, a third subject of the invention relates to an optical article comprising the amorphous thermoplastic polyester described above.

The amorphous thermoplastic polyesters used in the present invention have a glass transition temperature of at least 116° C., a high reduced solution viscosity and a low birefringence and have excellent impact strength and scratch resistance properties, which is particularly advantageous for use in the production of optical articles.

### DETAILED DESCRIPTION OF THE INVENTION

A first subject of the invention relates to the use of an amorphous thermoplastic polyester for the production of optical articles, said amorphous thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);

the (A)/[(A)+(B)] molar ratio being at least 0.32 and at most 0.90 and the reduced solution viscosity being greater than 50 ml/g.

(A)/[(A)+(B)] molar ratio is intended to mean the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A).

The amorphous thermoplastic polyester does not contain any aliphatic non-cyclic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol unit is advantageously less than 1%. Preferably, the polyester does not contain any aliphatic non-cyclic diol units and more preferentially it does not contain any ethylene glycol.

Despite the low amount of aliphatic non-cyclic diol, and hence of ethylene glycol, used for the synthesis, an amorphous thermoplastic polyester is surprisingly obtained which has a high reduced viscosity in solution and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol and may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. The alicyclic diol (B) is very preferentially 1,4-cyclohexanedimethanol. The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) is at least 0.32 and at most 0.90. Advantageously, this ratio is at least 0.35 and at most 0.70, and more particularly this ratio is at least 0.40 and at most 0.65.

The amorphous thermoplastic polyesters that are particularly suitable for the production of optical articles may for example comprise:
a molar amount of 1,4:3,6-dianhydrohexitol units (A) ranging from 16 to 54%;
a molar amount of alicyclic diol units (B) other than the 1,4:3,6-dianhydrohexitol units (A) ranging from 5 to 30%;
a molar amount of terephthalic acid units (C) ranging from 45 to 55%.

The amounts of different units in the polyester may be determined by 1H NMR or by chromatographic analysis of the mixture of monomers resulting from complete hydrolysis or methanolysis of the polyester, preferably by 1H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The amorphous thermoplastic polyesters thus prepared have a glass transition temperature of at least 116° C. and at most 200° C. Preferentially, the glass transition temperature is at least 118° C., very preferentially at least 120° C. and even more preferentially at least 122° C. and at most 190° C. The glass transition temperature is measured by conventional methods, in particular using differential scanning calorimetry (DSC) using a heating rate of 10° C./min. The experimental protocol is described in detail in the examples section below.

They also in particular have a lightness L* greater than 40. Advantageously, the lightness L* is greater than 55, preferably greater than 60, most preferentially greater than 65, for example greater than 70. The parameter L* may be determined using a spectrophotometer, via the CIE Lab model.

Finally, the reduced viscosity in solution is greater than 50 ml/g and less than 150 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/l.

This test for measuring reduced solution viscosity is, due to the choice of solvents and the concentration of the polymers used, perfectly suited to determining the viscosity of the viscous polymer prepared according to the process described.

The amorphous character of the thermoplastic polyesters used according to the present invention is characterized by the absence of X-ray diffraction lines and also by the absence of an endothermic fusion peak in differential scanning calorimetry analysis.

The amorphous thermoplastic polyesters prepared according to the process previously described have excellent properties for the production of optical articles.

Indeed, especially by virtue of the (A)/[(A)+(B)] molar ratio of at least 0.32 and at most 0.90, and of a reduced solution viscosity of greater than 50 ml/g and preferably less than 150 ml/g, the amorphous thermoplastic polyesters have better heat resistance when they are blow molded, and make it possible to obtain optical properties, such as transparency or birefringence, which are thereby improved. Furthermore, they have good scratch resistance and they are metallizable.

For the purposes of the present invention, the optical articles are for example CDs (acronym of compact discs), DVDs (acronym of digital versatile discs), optical lenses, Fresnel lenses, dashboard windows, prism reflectors, transparent sheets or films, films for LCD screens, light-emitting diode components, or else optical fibers.

The use according to the invention, the production of optical articles from amorphous thermoplastic polyesters described above, can require a step of forming by one or more techniques commonly used for plastics, including for example injection molding, compression molding, injection-compression molding, and extrusion through a die, it being possible for said techniques to be implemented for designing in particular fibers, films, sheets, bars, plates, granules or rods.

Advantageously, the production of optical articles from amorphous thermoplastic polyesters according to the invention can be carried out by injection molding or injection-compression molding. The production is preferentially carried out by injection molding.

According to one embodiment, the amorphous thermoplastic polyester may be packaged after polymerization in a form that is easy to handle, such as pellets or granules, before being used for the production of optical articles. Preferentially, the amorphous thermoplastic polyester is packaged in the form of granules, said granules being advantageously dried before conversion into the form of optical articles. The drying is carried out so as to obtain granules having a residual moisture content of less than 300 ppm, for instance approximately 230 ppm.

According to one particular embodiment, and regardless of the method used for producing the optical article, the amorphous thermoplastic polyester previously defined may be used in combination with one or more additional polymers.

The additional polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s such as poly(2,6-dimethylphenylene oxide), poly(phenylene sulfate)s, poly(ester-carbonate)s, polycarbonates, polysulfones, polysulfone ethers, polyether ketones, and blendtures of these polymers.

The additional polymer may also be a polymer which makes it possible to improve the impact properties of the polymer, especially functional polyolefins such as functionalized ethylene or propylene polymers and copolymers, core-shell copolymers or block copolymers.

During the production of the optical article from the amorphous thermoplastic polyester, one or more additives may also be added in order to give the finished product particular properties.

Thus, the additive may for example be chosen from demolding agents, such as Incromold™ from Croda, UV-resistance agents such as, for example, molecules of benzophenone or benzotriazole type, such as the Tinuvin™ range from BASF: tinuvin 326, tinuvin P or tinuvin 234, for example, or hindered amines such as the Chimassorb™ range from BASF: Chimassorb 2020, Chimasorb 81 or Chimassorb 944, for example.

The additive may also be a fire-proofing agent or flame retardant, such as, for example, halogenated derivatives or non-halogenated flame retardants (for example phosphorus-based derivatives such as Exolit® OP) or such as the range of melamine cyanurates (for example Melapur™: melapur 200), or else aluminum or magnesium hydroxides.

A second subject of the invention relates to a process for producing an optical article, said process comprising the following steps of:
provision of an amorphous thermoplastic polyester as defined above,
preparation of said optical article from the amorphous thermoplastic polyester obtained in the preceding step.

The preparation step can be carried out by the techniques known to those skilled in the art, for instance injection molding or injection-compression molding. The preparation is preferentially carried out by injection molding.

A third subject of the invention relates to optical articles comprising the amorphous thermoplastic polyester described above. The optical articles may also comprise one or more additional polymers and/or one or more additives as previously defined.

The amorphous thermoplastic polyesters described above for the production of optical articles may be prepared by means of a production process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum, at a temperature ranging from 278 to 300° C. so as to form the polyester, advantageously from 280 to 290° C., for example 285° C.;
a step of recovering the amorphous thermoplastic polyester;

wherein the molar ratio ((A)+(B))/(C) ranges from 1.05 to 1.50.

The polymer obtained thus has a reduced solution viscosity of greater than 50 ml/g. This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example, after having introduced the monomers into the reactor, by generating a vacuum and then by introducing an inert gas such as nitrogen into the reactor. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage being the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011/282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

The process also comprises a step of recovering the amorphous thermoplastic polyester at the end of the polymerization step. The polyester can be recovered by extraction in the form of a molten polymer rod. This rod can be converted into granules using conventional granulation techniques.

The invention will be understood more clearly by means of the examples and figures which follow, which are intended to be purely illustrative and do not in any way limit the scope of the protection.

### FIGURES

FIG. 1A: Photo of a plate produced with an amorphous thermoplastic polyester according to the invention.

FIG. 1B: Photo of a plate not produced with an amorphous thermoplastic polyester according to the invention.

### EXAMPLE

The properties of the polymers were studied via the following techniques:

Reduced Solution Viscosity

The reduced solution viscosity is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

DSC

The thermal properties of the polyesters were measured by differential scanning calorimetry (DSC): the sample is first heated under a nitrogen atmosphere in an open crucible from 10° C. to 320° C. (10° C.min⁻¹), cooled to 10° C. (10° C.min⁻¹), then heated again to 320° C. under the same conditions as the first step. The glass transition temperatures were taken at the mid-point of the second heating. Any melting points are determined on the endothermic peak (onset) at the first heating. Similarly, the enthalpy of fusion (area under the curve) is determined at the first heating.

For the illustrative examples presented below, the following reagents were used:

1,4-Cyclohexanedimethanol (99% purity, mixture of cis and trans isomers)

Isosorbide (purity >99.5%) Polysorb® P from Roquette Frères

Terephthalic acid (99+% purity) from Acros

Irganox® 1010 from BASF AG

Dibutyltin oxide (98% purity) from Sigma Aldrich

Preparation and Forming of an Amorphous Thermoplastic Polyester

A: Polymerization

Two thermoplastic polyesters P1 and P2 were prepared according to the procedure described below with the amounts of reagents detailed in table 1. P1 is an amorphous thermoplastic polyester prepared for use according to the invention with in particular a molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A) of at least 0.32, whereas P2 is a polyester that serves as a comparison, with an (A)/[(A)+(B)] molar ratio of 0.1.

859 g (6 mol) of 1,4-cyclohexanedimethanol, 871 g (6 mol) of isosorbide, 1800 g (10.8 mol) of terephthalic acid, 1.5 g of Irganox 1010 (antioxidant) and 1.23 g of dibutyltin oxide (catalyst) are added to a 7.5 l reactor.

To extract the residual oxygen from the isosorbide crystals, four vacuum-nitrogen cycles are performed once the temperature of the reaction medium is between 60° C. and 80° C. The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over 90 minutes following a logarithmic ramp and the temperature is brought to 285° C.

These vacuum and temperature conditions were maintained until an increase in torque of 10 Nm relative to the initial torque was obtained.

Finally, a polymer rod is cast via the bottom valve of the reactor, cooled to 15° C. in a heat-regulated water bath and chopped in the form of granules of about 15 mg.

TABLE 1

| | | POLYESTERS | | | |
|---|---|---|---|---|---|
| | | P1 | | P2 | |
| COM- | 1,4-cyclohexane- | 859 g | (6 mol) | 1680 g | (11.6 mol) |
| POUNDS | dimethanol | | | | |
| | Isosorbide | 871 g | (6 mol) | 233 g | (1.6 mol) |
| | Terephthalic | 1800 g | (10.8 mol) | 2000 g | (12 mol) |
| | acid | | | | |

| | | |
|---|---|---|
| Irganox (anti- | 1.5 g | 1.66 g |
| oxidant) | | |
| Dibutyltin | 1.23 g | 1.39 g |
| oxide (catalyst) | | |

The properties of the resins obtained for polyesters P1 and P2 are summarized in table 2 below:

TABLE 2

| | | POLYESTERS | | | |
|---|---|---|---|---|---|
| | | P1 | | P2 | |
| PROPERTIES | Reduced solution | 54.9 | ml/g | 69.9 | ml/g |
| | viscosity | | | | |
| | Mol % of isosorbide | 44 | | 6.4 | |
| | relative to the diols | | | | |
| | Glass transition | 125° | C. | 91° | C. |
| | temperature | | | | |

With regard to the thermal properties, the readings were taken at the second heating.

B: Injection

The granules of the polyesters P1 and P2 are vacuum-dried at 110° C. in order to achieve residual moisture contents of less than 300 ppm and, in particular in this example, the water content of the granules is 230 ppm.

The injection molding is carried out on an Engel Victory 80® press.

The granules, kept in a dry atmosphere, are introduced into the hopper of the injection-molding press. The granules are injection-molded in the form of a plate 2 mm thick and the injection-molding parameters are summarized in table 3 below:

TABLE 3

| Name | Units | P1 | P2 |
|---|---|---|---|
| Temperature of the molten | ° C. | 270/265/265/260 | 290/285/280/275 |
| plastic (nozzle/tube) | | | |
| Mold temperature | ° C. | 50 | 50 |
| Injection speed | mm/s | 80 | 80 |
| Holding pressure | bar | 23 | 24 |
| Holding time | s | 15 | 20 |
| Cooling time | s | 15 | 20 |

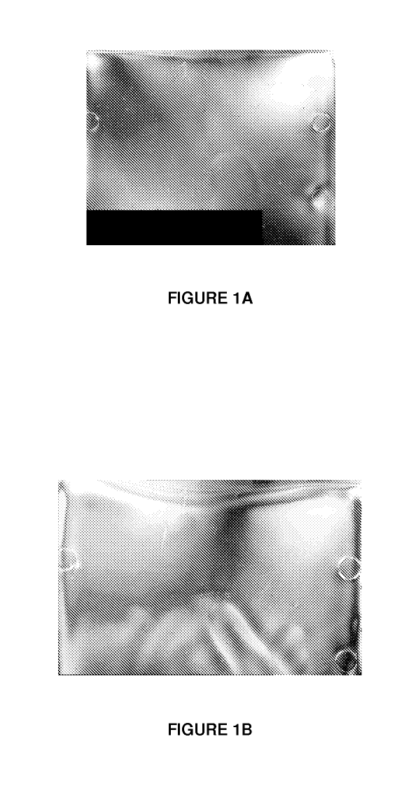

The plates obtained with these parameters have very different properties, as shown by FIGS. 1A and 1B which represent the photos of the two plates obtained with the thermoplastic polyesters P1 and P2 respectively.

The amorphous thermoplastic polyester P1 makes it possible to obtain plates which have advantageous optical properties and in particular a low birefringence. Conversely, the polyester P2, which does not contain an (A)/[(A)+(B)] molar ratio of at least 0.32, has a birefringence that is too high and is incompatible with use for the production of optical articles.

1-22. (canceled)

23. An optical article, comprising an amorphous thermoplastic polyester comprising:
at least one 1,4:3,6-dianhydrohexitol unit (A);
at least one alicyclic diol unit (B) other than the 1,4:3,6-dianhydrohexitol units (A); and
at least one terephthalic acid unit (C);
the (A)/[(A)+(B)] molar ratio being at least 0.32 and at most 0.90;
said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g.

24. The optical article according to claim 23, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

25. The optical article according to claim 23, wherein the 1,4:3,6-dianhydrohexitol (A) is isosorbide.

26. The optical article according to claim 23, wherein the polyester does not contain any aliphatic non-cyclic diol units, or comprises a molar amount of aliphatic non-cyclic diol units, relative to all the monomer units of the polyester, of less than 1%.

27. The optical article according to claim 23, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

28. The optical article according to claim 23, wherein the optical article comprises one or more additional polymers and/or one or more additives.

29. The optical article according to claim 23, wherein the optical article is chosen from the group consisting of CDs (acronym of compact discs), DVDs (acronym of digital versatile discs), lenses, Fresnel lenses, dashboard windows, prism reflectors, transparent sheets or films, films for LCD screens, light-emitting diode components, or else optical fibers.

30. A method for the production of an optical article, comprising the following steps of:
provision of an amorphous thermoplastic polyester comprising at least one 1,4:3,6-dianhydrohexitol unit (A), at least one alicyclic diol unit (B) other than the 1,4:3,6-dianhydrohexitol units (A), at least one terephthalic acid unit (C), wherein the (A)/[(A)+(B)] molar ratio is at least 0.32 and at most 0.90, said polyester not containing any aliphatic non-cyclic diol units or comprising a molar amount of aliphatic non-cyclic diol units, relative to all the monomer units of the polyester, of less than 5%, and the reduced solution viscosity (25° C.; phenol (50% m): ortho-dichlorobenzene (50% m); 5 g/l of polyester) of said polyester being greater than 50 ml/g; and
preparation of said optical article from the amorphous thermoplastic polyester obtained in the preceding step.

31. The method according to claim 30, wherein the preparation step is carried out by injection molding.

32. The method according to claim 30, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

33. The method according to claim 30, wherein the 1,4:3,6-dianhydrohexitol (A) is isosorbide.

34. The method according to claim 30, wherein the polyester does not contain any aliphatic non-cyclic diol units, or comprises a molar amount of aliphatic non-cyclic diol units, relative to all the monomer units of the polyester, of less than 1%.

35. The method according to claim 30, wherein the (3,6-dianhydrohexitol unit (A)+alicyclic diol unit (B) other than the 1,4:3,6-dianhydrohexitol units (A))/(terephthalic acid unit (C)) molar ratio is from 1.05 to 1.5.

36. The method according to claim 30, wherein the optical article comprises one or more additional polymers and/or one or more additives.

37. The method according to claim 30, wherein the optical article is chosen from the group consisting of CDs (acronym of compact discs), DVDs (acronym of digital versatile discs), lenses, Fresnel lenses, dashboard windows, prism reflectors, transparent sheets or films, films for LCD screens, light-emitting diode components, or else optical fibers.
